(19) United States
(12) Patent Application Publication
(10) Pub. No.: US 2022/0269664 A1
(43) Pub. Date: Aug. 25, 2022

(54) SYSTEM AND METHOD FOR DATA VALIDATION AND EXCEPTION MONITORING

(71) Applicant: Ford Global Technologies, LLC, Dearborn, MI (US)

(72) Inventors: David Smith, Beverly Hills, MI (US); Samuel Paul Bryfczynski, Grosse Pointe Woods, MI (US); Matthew Burton, South Lyon, MI (US)

(73) Assignee: Ford Global Technologies, LLC, Dearborn, MI (US)

(21) Appl. No.: 17/182,852

(22) Filed: Feb. 23, 2021

(51) Int. Cl. G06F 16/23; G06F 16/22; G06F 16/25; G06F 16/2458; G06K 9/62; G06N 20/00

(52) U.S. Cl. CPC G06F 16/2308; G06F 16/2282; G06F 16/252; G06F 16/2462; G06K 9/6221; G06N 20/00

(57) ABSTRACT

A staging data store includes transaction data from one or more entities. An evaluation server programmed to determine one or more transaction types in the transaction data, to input second transaction data for each of the transaction types into one or more predictive models to generate one or more exception probabilities for transactions in the transaction data, and to output one or more risk scores for the transactions based on the exception probabilities.

### BACKGROUND

Data for different but similar entities can be dispersed at various entity locations. Entity data can reflect activity at an entity, but may be incorrect or inaccurate. For example, an entity such as a provider of a product may store data related to product transactions. The product transactions may include various parameters that can be stored by the entity. To determine whether entity transaction data, e.g., parameters describing a transaction, are accurate and/or correct, can be challenging in light of existing data and/or network architectures.

### BRIEF DESCRIPTION OF THE DRAWINGS

FIG. 1 is a block diagram illustrating an exemplary data processing system.

FIG. 2 is a process flow diagram of an example process for generating exception probabilities.

FIG. 3 is a process flow diagram of an example process for training a predictive model for generating exception probabilities.

FIG. 4 is a process flow diagram of an example process for generating exception probabilities.

### DETAILED DESCRIPTION

A networked computer architecture provides for utilization of data from a plurality of entity data sources to generate and/or train one or more predictive models. Once trained, a predictive model can be implemented, e.g., on a central server, to output and evaluate exception probabilities for current data from one of the plurality of entities or some other like entity. The predictive models can include clustering, machine learning, grid searching, k-fold cross validation, probability calibration, etc., and can include historical transaction data aggregated from the entity data sources. A central server can retrieve the aggregated data and provide it as input to one or more of the predictive models to determine and/or rank exception probabilities for the current entity data. The exception probabilities can specify an exception probability, i.e., a risk or probability that a transaction or set of transactions is exceptional, i.e., that the transaction(s) meet one or more criteria indicating a risk to be output to a user.

A system can comprise a staging data store including transaction data from one or more entities. The system can further comprise an evaluation server programmed to determine one or more transaction types in the transaction data; input second transaction data for each of the transaction types into one or more predictive models to generate one or more exception probabilities for transactions in the transaction data; and output one or more risk scores for the transactions based on the exception probabilities.

The one or more predictive models can be a plurality of predictive models, wherein each of the predictive models is provided for a corresponding one of the transaction types.

The evaluation server can be further programmed to output the one or more risk scores based on combining some or all of the predictive models. The evaluation server can be further programmed to combine the predictive models by applying a statistical measure to the one or more risk scores for the transactions. The evaluation server can be further programmed to output an aggregated risk score based on the one or more risk scores for the transactions. The evaluation server can be further programmed to output an aggregated risk score based on a predictive model that evaluates the respective individual transactions of a transaction type. The evaluation server can be further programmed to rank the risk scores.

The one or more predictive models can one or more of grid search, k-fold cross validation, or probability calibration. The one or more predictive models can include one or more of a clustering algorithm or a machine learning program.

The system can further comprise a training server programmed to generate one or more of the one or more predictive models. The staging server can be programmed to obtain training data from one or more entities and to provide the training data to the training server.

A method can comprise obtaining transaction data from one or more entities; determining one or more transaction types in the transaction data; inputting second transaction data for each of the transaction types into one or more predictive models to generate one or more exception probabilities for transactions in the transaction data; and outputting one or more risk scores for the transactions based on the exception probabilities.

The one or more predictive models can be a plurality of predictive models, wherein each of the predictive models is provided for a corresponding one of the transaction types.

The method can further comprise outputting the one or more risk scores based on combining some or all of the predictive models. The method can further comprise combining the predictive models by applying a statistical measure to the one or more risk scores for the transactions.

The method can further comprise outputting an aggregated risk score based on the one or more risk scores for the transactions.

The method can further comprise outputting an aggregated risk score based on a predictive model that evaluates the respective individual transactions of a transaction type.

The one or more predictive models can include one or more of grid search, k-fold cross validation, probability calibration, a clustering algorithm, or a machine learning program.

The method can further comprise generating one or more of the one or more predictive models.

The method can further comprise obtaining the training data from the one or more entities via a wide area network.

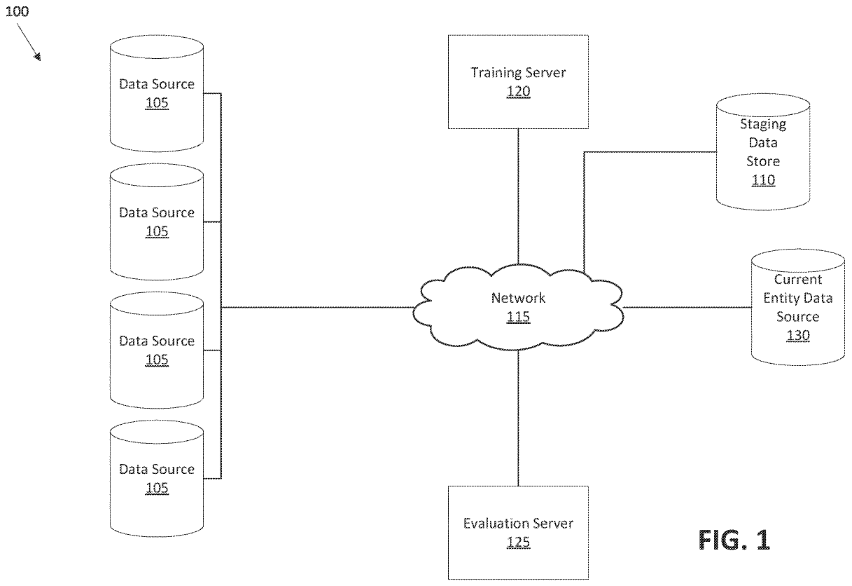

FIG. 1 is a block diagram illustrating an exemplary data processing system 100. As illustrated, a plurality of data sources 105 can provide various data to a staging data store 110, e.g., via a network 115. Each data source 105 is typically associated with an entity generating data stored in the data source 105, e.g., transaction data. Further, an entity can include multiple data sources 105 for different types of transaction data. A training server 120 can access data from the staging data store 110 for creating and/or training one or more predictive models. An evaluation server 125 can implement the one or more predictive models and can obtain data from a current entity data source 130 to be input to one or more predictive models to output an exception probability.

The data sources 105 are typically databases or files stored in a non-volatile memory included in or attached to an entity computer. For example, an entity could have a computer including a processor and a memory, and possibly also peripheral storage. A data source 105 could thus be provided from an entity computer memory and/or peripheral storage, e.g., from a relational database, a file, or the like. For example, an entity could be a dealer such as an automotive dealer, and an entity data source 105 could include data from the entity's sales transactions. The data sources may include transaction data such as data related to incentive claims and/or program information, sales transaction information, dealer information, incentive plan sponsor information, dealer employee information, customer information, etc. Transaction data is any data stored by an entity relating to a transaction, or at least purporting to relate to a transaction, that the entity conducts or has conducted with another entity. Transaction data can be incorrect or inaccurate, i.e., can include a wrong value related to a transaction, such as a wrong transaction amount, transaction type, etc. A predictive model trained with transaction data from one or more data sources 105 can be used to evaluate a risk that one or more transactions included in transaction data from a current entity data source 130 are incorrect or inaccurate.

In one example, entity data sources 105 include transaction data recorded from sales transactions at the entity. For example, transaction data (sometimes also referred to as entity data) could be organized in tables, files, or the like, including data fields such as:
transaction date;
entity identifier;
product identifier (e.g., a vehicle identification number or VIN);
program identifier (e.g., an identifier for a dealer incentive program, customer rebate program, etc.);
transaction amount (e.g., amount of the sale).

The staging data store 110 includes transaction data from entity data sources 105 for a plurality of entities. For example, transaction data could be obtained from data sources 105 via the network 115, e.g., using conventional querying and/or scraping techniques. Alternatively or additionally, transaction data from one or more entity data sources 105 could be loaded onto a data store 110 from portable computer-readable media. The staging data store 110 includes a computer including a processor and a memory, and possibly also peripheral storage. In the staging data store 110, transaction data a plurality of data sources 105 can be combined, e.g., concatenated or placed together in a single table, file. etc., and/or statistically aggregated, e.g., fields in data from data sources 105 could be averaged, summed, etc. Data from the staging data store 110 can then be provided to a training server 120 for training one or more predictive models. Thus, data stored in the staging data store 110 can be used to create a training data set to be used to create and train one or more predictive models that can then be used to generate exception probabilities for newly input entity data, e.g., current entity transaction data, from a current entity data source 130. In one example, data from entity data sources 105 and/or current data sources 130 is provided to a staging data store 110 and stored in Microsoft Excel files. A scraping program created in the Python programming language is then used to extract data from a Microsoft Excel file or files to be input to a predictive model, e.g., implemented on an evaluation server 125

The network 115 represents one or more mechanisms by which a computer may communicate with remote computing devices, e.g., the training server 120, the evaluation server 125, other computers, etc. Accordingly, the network 115 can be one or more of various wired or wireless communication mechanisms, including any desired combination of wired (e.g., cable and fiber) and/or wireless (e.g., cellular, wireless, satellite, microwave, and radio frequency) communication mechanisms and any desired network topology (or topologies when multiple communication mechanisms are utilized). The network 115 is typically a wide area network, e.g., including the Internet. The network 115 may include other wireless communication networks (e.g., using Bluetooth®, Bluetooth® Low Energy (BLE), IEEE 802.11, etc.), and/or local area networks (LAN) providing data communication services.

The training server 120 and the evaluation server 125 (which could be implemented on a single central server, but are discussed herein separately for ease of illustration), are typically general purpose computers including a processor and a memory. These and other computers discussed herein may comprise one or more processors, memory, and a plurality of instructions (by way of example only, software code) which is stored on memory and which is executable by processor(s). Processor(s) may be programmed to process and/or execute digital instructions, e.g., predictive modeling, to carry out at least some of the tasks described herein. Non-limiting examples of processor(s) include one or more of a microprocessor, a microcontroller or controller, an application specific integrated circuit (ASIC), a field-programmable gate array (FPGA), one or more electrical circuits comprising discrete digital and/or analog electronic components arranged to perform predetermined tasks or instructions, etc., just to name a few. In at least one example, processor(s) read from the memory and execute multiple sets of instructions which may be embodied as a computer program product stored on a non-transitory computer-readable storage medium (e.g., such as memory). Non-limiting examples of instructions will be described below in the processes illustrated using flow diagrams and described elsewhere herein, wherein these and other instructions may be executed in any suitable sequence unless otherwise stated. The instructions and the example processes described below are merely embodiments and are not intended to be limiting.

A computer memory, e.g., included in a data source 105, 130, a data store 110, or server 120, 125 may include any non-transitory computer usable or readable medium, which may include one or more storage devices or storage articles. Exemplary non-transitory computer usable storage devices include conventional hard disk, solid-state memory, random access memory (RAM), read-only memory (ROM), erasable programmable read-only memory (EPROM), electrically erasable programmable read-only memory (EEPROM), as well as any other volatile or non-volatile media. Non-volatile media include, for example, optical or magnetic disks and other persistent memory, and volatile media, for example, also may include dynamic random-access memory (DRAM). These storage devices are non-limiting examples; e.g., other forms of computer-readable media exist and include magnetic media, compact disc ROM (CD-ROMs), digital video disc (DVDs), other optical media, any suitable memory chip or cartridge, or any other medium from which a computer can read. As discussed above, memory may store one or more sets of instructions (e.g., such as instructions) which may be embodied as software, firmware, or other programming instructions executable by the processor(s), including but not limited to the instruction examples set forth herein. In operation, processor(s) may read data from, and/or write data to, memory.

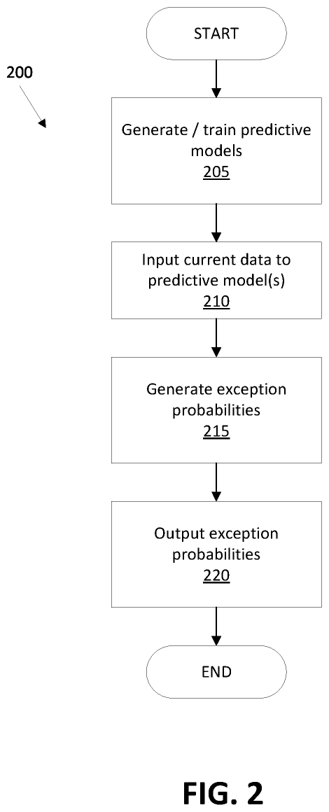

FIG. 2 is a process flow diagram of an example process 200 for generating exception probabilities for transaction data, i.e., as explained above an exception probability is a risk score or the like specifying a probability that input transaction data is exceptional, e.g., that the data is incorrect because it does not represent a real transaction and/or that the data represents an improper transaction. The process 200 includes training one or more predictive models with data from a plurality of entity data sources 105. Then, based on data from a current data source 130 that is input to the one or more predictive models, output from the example process 200 can include exception probabilities for specific transactions or sets of transactions, e.g., transactions with exception probabilities at or above threshold, i.e., deemed likely to have inaccurate or incorrect data, can be identified. Further the exception probabilities may be sorted, e.g., ranked from highest risk to lowest to show which individual transactions have a higher risk of being inaccurate or incorrect.

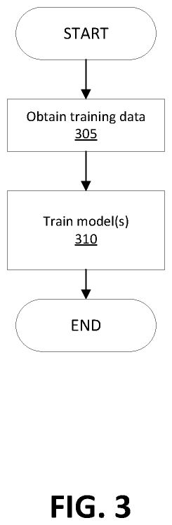

In a block 205, one or more predictive models are trained using data from staging data store 110 that has been obtained from a plurality of entity data sources 105. For example, the data may include data relating to sales transactions, including sales prices, sales dates, identification of products sold, and/or dealer incentives paid for the transaction. Various predictive models, e.g., a deep neural network or tree-based classifier, using machine learning, clustering, etc., and using various techniques to improve accuracy, e.g., grid searching, k-fold cross validation, probability calibration, etc., are possible. Creating and/or training a predictive model is described further below with respect to FIG. 3.

In a block 210, data from a current entity data source 130 is input to one or more predictive models. For example, an entity data source 130 could be an automotive dealer or the like, and the data from the source 130 could include data relating to a set of transactions for a specified time range, e.g., a month, quarter, a year.

In a block 215, exception probabilities are generated for the current entity data input to the one or more predictive models in the block 210.

In a block 220, one or more exception probabilities for respective individual transactions and/or groups of transactions are output. For example, exception probabilities for individual transactions in a set of transactions from a current entity data source 130 could be output and/or exception probabilities could be aggregated for a set of transactions, e.g., an average exception probability for all transactions in a time range and/or for a specific product could be provided. Alternatively or additionally, an aggregated exception probability or risk score could be provided for an entity, e.g., for a plurality of transaction plurality of transaction types processed by the entity. For example, output could include:
transaction identifier (or an identifier for a set of transactions);
transaction date (or a range of dates for a set of transactions):
entity identifier;
product identifier (e.g., a vehicle identification number or VIN), could be omitted or could be multiple product identifiers for a set of transactions;
program identifier (e.g., an identifier for a dealer incentive program, customer rebate program, etc.);
transaction amount (e.g., amount of the sale), could be in average or other statistical representation for a set of transactions;
exception probability or risk score (e.g., a percentage or scaler number, e.g., on a scale of 0 to 10 or 0 to 100, etc.), specifying a probability that a transaction has incorrect data.

The process 200 ends after the block 220.

FIG. 3 is a process flow diagram of an example process 300 for training a predictive model for generating exception probabilities.

The process 300 begins in a block 305, in which training data is provided to or obtained by a training server 120. For example, various mechanisms can be used from a staging data store 110 to extract data from entity data sources 105, and to provide the data to a training server 120 in various formats. A data source 105 may store entity data in a relational database, a spreadsheet file, a text file, etc. Accordingly, an entity data source 105 may provide training data in response to a query to a relational database, and extraction tool that obtains data from a spreadsheet or text file, etc. Training data typically includes records that each have a plurality of fields describing a transaction, i.e., training data typically includes historical transaction data from a plurality of entities. The training data typically also includes metadata, e.g., identifying an entity whose entity data source 105 provided the training data.

Training data is typically selected according to a type or types of transactions. A transaction type is a description of a transaction that specifies an entity's counter-party to the transaction and the entity's payment for the transaction. For example, a transaction type could be “product sale,” where the entity's counter-party is a customer purchasing a product, and the entity's payment for the transaction is revenue received for the product sale. In another example, a transaction type could be “dealer incentive,” where the entity's counterparty is an original equipment manufacturer (OEM) offering the incentive, in the entity's payment for the transaction is compensation, e.g., a payment or rebate, provided to the entity by the OEM.

Training data can also be selected according to a date, or more typically, a date range. For example, training data may include set of transaction data for respective months for a specified number of months, e.g., 12 months (i.e., one year).

Following the block 305, in a block 310, a predictive model or models can be developed based on the training data obtained by the training server 120. Various machine learning techniques could be used. For example, a deep neural network could be trained to accept as input transaction data, and to output an exception probability. Training data could include transactions of predetermined exception probabilities, e.g., based on prior audits of the data from entity data source 105, and the deep neural network could be trained based on these known exception probabilities. Techniques such as grid search, k-fold cross validation, and probability calibration could be used to enhance the accuracy of a predictive model, e.g., to further tune a neural network. Alternatively or additionally, tree-based classifiers or clustering techniques could be used, e.g., RandomForest, ExtraTrees, and/or GradientBoostedTrees. Further, the training server 120 could be used to build various predictive models for various transaction types. Predictive models can be built using a variety of technologies; in one example, the Python programming language was used. For example, if an entity is an automotive dealer, the entity could participate in incentive programs of different types. Different predictive models could be built for different respective incentive programs.

Following the block 310, the process 300 ends.

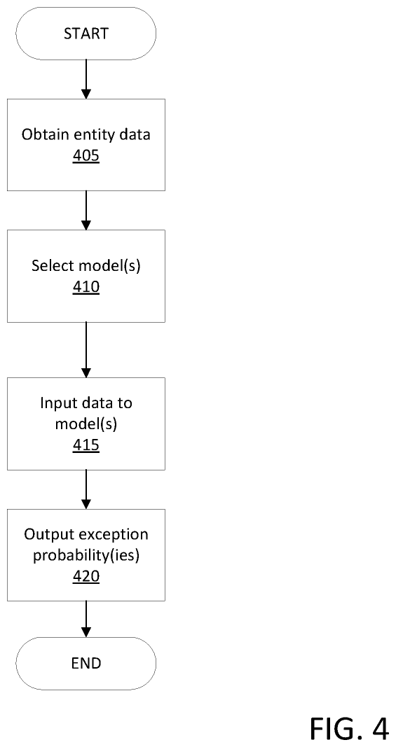

FIG. 4 is a process flow diagram of an example process 400 for generating exception probabilities.

The process 400 begins in a block 405, in which an evaluation server 125 can obtain data from a current entity data source 130. The data can be data describing a plurality of transactions such as described above. The evaluation server 125 can have implemented thereon one or more predictive models such as described above. One or more transaction types can be selected for evaluation for one or more dates or, more typically date ranges, from data stored in a current entity data source 130.

In a block 410, which follows the block 405, one or more predictive models can be selected for evaluating the data from the current entity data source 130. For example, as mentioned above, different predictive models can be provided for different types of transaction data. Accordingly, a predictive model can be selected for a corresponding transaction type, i.e., a type of transaction that the predictive model was trained to analyze for exception probabilities. Further, a plurality of respective predictive models can be selected for a plurality of corresponding transaction types in the data from the current entity data source 130. Yet further, a plurality of predictive models, e.g., of different types, can be developed for a single transaction type. For example, data for a single transaction type from a current entity data source 130 can be input to respective predictive models, whose output can then be combined, e.g., average or subjected to some other statistical measure, to generate respective exception probabilities for transactions.

In a block 415, which follows the block 410, current entity data obtained in the block 405 can be input into the selected predictive model(s) of the block 410.

In a block 420, which follows the block 415, one or more exception probabilities can be output for the data evaluated in the block 415 (i.e., input to the selected predictive model(s)). For example, exception probability can be assigned to a set of transaction data records, and/or respective exception probabilities can be assigned to individual transaction data records, i.e., individual transactions. The output could a list of individual transactions obtained from the current entity data source 130 to indicate which of the current entity transactions are exceptional, i.e., that the transaction data is incorrect or inaccurate because it does not represent a real transaction and/or that the data represents an improper transaction, along with risk scores for respective transactions, i.e., exception probabilities that indicate a risk, e.g., on a scale of zero to 1, or 1 to 10 or 1 to 100, that a transaction includes incorrect and/or improper data. As noted above, exception probability can be a binary indication, e.g., yes/no, or can measure a risk associated with the transaction, e.g., a percentage likelihood that a transaction includes inaccurate or incorrect data, a score on a scale e.g., of 0 to 10, etc. Further, output could rank transactions or set of transactions according to such risk measurements. Yet further, as noted above, exception probability for a transaction could be determined by combining output exception probabilities of two or more predictive models for the transaction. Yet further, output could include an aggregated exception probability or risk score for a set of transactions, e.g., an average of risk scores for individual transactions and/or an aggregated risk score obtained from a predictive model trained to evaluate a set of transactions and output the aggregated risk score for the set of transactions based on a type of the set of transactions. For example, an aggregated risk score can be provided for an entity, e.g., for a plurality of transaction types processed by the entity.

Following the block 420, the process 400 ends.

### Further Information

In general, the computing systems and/or devices described may employ any of a number of computer operating systems, including, but by no means limited to, versions and/or varieties of the Microsoft Windows® operating system, the Unix operating system (e.g., the Solaris® operating system distributed by Oracle Corporation of Redwood Shores, Calif.), the AIX UNIX operating system distributed by International Business Machines of Armonk, N.Y., the Linux operating system, the Mac OSX and iOS operating systems distributed by Apple Inc. of Cupertino, Calif., etc.

Computers and computing devices generally include computer executable instructions, where the instructions may be executable by one or more computing devices such as those listed above. Computer executable instructions may be compiled or interpreted from computer programs created using a variety of programming languages and/or technologies, including, without limitation, and either alone or in combination, Java™, C, C++, Python, Matlab, Simulink, Stateflow, Visual Basic, Java Script, Perl, HTML, etc. Some of these applications may be compiled and executed on a virtual machine, such as the Java Virtual Machine, the Dalvik virtual machine, or the like. In general, a processor (e.g., a microprocessor) receives instructions, e.g., from a memory, a computer readable medium, etc., and executes these instructions, thereby performing one or more processes, including one or more of the processes described herein. Such instructions and other data may be stored and transmitted using a variety of computer readable media. A file in a computing device is generally a collection of data stored on a computer readable medium, such as a storage medium, a random access memory, etc.

Memory may include a computer readable medium (also referred to as a processor readable medium) that includes any non transitory (e.g., tangible) medium that participates in providing data (e.g., instructions) that may be read by a computer (e.g., by a processor of a computer). Such a medium may take many forms, including, but not limited to, non volatile media and volatile media. Non volatile media may include, for example, optical or magnetic disks and other persistent memory. Volatile media may include, for example, dynamic random access memory (DRAM), which typically constitutes a main memory. Such instructions may be transmitted by one or more transmission media, including coaxial cables, copper wire and fiber optics, including the wires that comprise a system bus coupled to a processor of an ECU. Common forms of computer readable media include, for example, a floppy disk, a flexible disk, hard disk, magnetic tape, any other magnetic medium, a CD ROM, DVD, any other optical medium, a RAM, a PROM, an EPROM, a FLASH EEPROM, any other memory chip or cartridge, or any other physical medium from which a computer can read.

Databases, data repositories or other data stores described herein may include various kinds of mechanisms for storing, accessing, and retrieving various kinds of data, including a hierarchical database, a set of files in a file system, an application database in a proprietary format, a relational database management system (RDBMS), etc. Each such data store is generally included within a computing device employing a computer operating system such as one of those mentioned above, and are accessed via a network in any one or more of a variety of manners. A file system may be accessible from a computer operating system, and may include files stored in various formats. An RDBMS generally employs the Structured Query Language (SQL) in addition to a language for creating, storing, editing, and executing stored procedures, such as the PL/SQL language mentioned above.

In some examples, system elements may be implemented as computer readable instructions (e.g., software) on one or more computing devices (e.g., servers, personal computers, etc.), stored on computer readable media associated therewith (e.g., disks, memories, etc.). A computer program product may comprise such instructions stored on computer readable media for carrying out the functions described herein.

With regard to the media, processes, systems, methods, heuristics, etc. described herein, it should be understood that, although the steps of such processes, etc. have been described as occurring according to a certain ordered sequence, such processes may be practiced with the described steps performed in an order other than the order described herein. It further should be understood that certain steps may be performed simultaneously, that other steps may be added, or that certain steps described herein may be omitted. In other words, the descriptions of processes herein are provided for the purpose of illustrating certain embodiments, and should in no way be construed so as to limit the claims.

Accordingly, it is to be understood that the above description is intended to be illustrative and not restrictive. Many embodiments and applications other than the examples provided would be apparent to those of skill in the art upon reading the above description. The scope of the invention should be determined, not with reference to the above description, but should instead be determined with reference to the appended claims, along with the full scope of equivalents to which such claims are entitled. It is anticipated and intended that future developments will occur in the arts discussed herein, and that the disclosed systems and methods will be incorporated into such future embodiments. In sum, it should be understood that the invention is capable of modification and variation and is limited only by the following claims.

All terms used in the claims are intended to be given their plain and ordinary meanings as understood by those skilled in the art unless an explicit indication to the contrary in made herein. In particular, use of the singular articles such as “a,” “the,” “said,” etc. should be read to recite one or more of the indicated elements unless a claim recites an explicit limitation to the contrary.

What is claimed is:

1. A system, comprising:
a staging data store including transaction data from one or more entities;
an evaluation server programmed to:
determine one or more transaction types in the transaction data;
input second transaction data for each of the transaction types into one or more predictive models to generate one or more exception probabilities for transactions in the transaction data; and
output one or more risk scores for the transactions based on the exception probabilities.

2. The system of claim 1, wherein the one or more predictive models is a plurality of predictive models, wherein each of the predictive models is provided for a corresponding one of the transaction types.

3. The system of claim 2, wherein the evaluation server is further programmed to output the one or more risk scores based on combining some or all of the predictive models.

4. The system of claim 3, wherein the evaluation server is further programmed to combine the predictive models by applying a statistical measure to the one or more risk scores for the transactions.

5. The system of claim 1, wherein evaluation server is further programmed to output an aggregated risk score based on the one or more risk scores for the transactions.

6. The system of claim 1, wherein the evaluation server is further programmed to output an aggregated risk score based on a predictive model that evaluates the respective individual transactions of a transaction type.

7. The system of claim 1, wherein evaluation server is further programmed to rank the risk scores.

8. The system of claim 1, wherein the one or more predictive models includes one or more of grid search, k-fold cross validation, or probability calibration.

9. The system of claim 1, wherein the one or more predictive models includes one or more of a clustering algorithm or a machine learning program.

10. The system of claim 1, further comprising a training server programmed to generate one or more of the one or more predictive models.

11. The system of claim 10, wherein the staging server is programmed to obtain training data from one or more entities and to provide the training data to the training server.

12. A method, comprising:
obtaining transaction data from one or more entities;
determining one or more transaction types in the transaction data;
inputting second transaction data for each of the transaction types into one or more predictive models to generate one or more exception probabilities for transactions in the transaction data; and
outputting one or more risk scores for the transactions based on the exception probabilities.

13. The method of claim 12, wherein the one or more predictive models is a plurality of predictive models, wherein each of the predictive models is provided for a corresponding one of the transaction types.

14. The method of claim 13, further comprising outputting the one or more risk scores based on combining some or all of the predictive models.

15. The method of claim 14, further comprising combining the predictive models by applying a statistical measure to the one or more risk scores for the transactions.

16. The method of claim 12, further comprising outputting an aggregated risk score based on the one or more risk scores for the transactions.

17. The method of claim 12, further comprising outputting an aggregated risk score based on a predictive model that evaluates the respective individual transactions of a transaction type.

18. The method of claim 12, wherein the one or more predictive models includes one or more of grid search, k-fold cross validation, probability calibration, a clustering algorithm, or a machine learning program.

19. The method of claim 12, further comprising generating one or more of the one or more predictive models.

20. The method of claim 19, further comprising obtaining the training data from the one or more entities via a wide area network.
